(19) United States
(12) Patent Application Publication
(10) Pub. No.: US 2008/0294637 A1
(43) Pub. Date: Nov. 27, 2008

(54) Web-Based User-Interactive Question-Answering Method and System

(76) Inventor: Wenyin Liu, Beijing (CN)

Correspondence Address: NORTH AMERICA INTELLECTUAL PROPERTY CORPORATION, P.O. BOX 506, MERRIFIELD, VA, 22116, US

(21) Appl. No.: 12/095,126

(22) PCT Filed: Dec. 28, 2006
(86) PCT No.: PCT/CN2006/003648

§ 371 Date: May 28, 2008

(30) Foreign Application Priority Data
Dec. 28, 2005 (CN) 200510130778.5

(51) Int. Cl. G06F 17/30; G06Q 30/00; G06F 17/27

(52) U.S. Cl. 707/6; 704/9; 705/26; 707/E17.015

(57) ABSTRACT

The disclosed subject matter consists of a system, a website, and their supporting methods for user-interactive question answering. The system consists of a pattern database to store question/answer patterns for users to select when asking/answering questions. Each question pattern may include or be associated with an answer pattern. The system also includes an asking unit to let the users ask questions with or without question patterns and processes users' questions. The system also includes an answering unit to let the users answer questions with or without answer patterns. The invented method and system can significantly improve users' questioning and answering efficiency and also help machines improve the accuracy of processing the questions and answers and accumulate useful knowledge.

### TECHNICAL FIELD

The following description relates to technologies in the fields of knowledge engineering, natural language processing, and Web information processing and management in general and techniques for user-interactive question-answering on the World Wide Web (Web) in particular. The invented techniques can help users efficiently ask and answer one another, and efficiently acquire, accumulate, and retrieve information and knowledge.

### BACKGROUND OF THE INVENTION

The World Word Web is now becoming a huge repository of information. However, it is not easy for users to quickly locate the information they need due to the large number of hyperlinks on the Web. So far, one of the important methods to solve the problem is searching based on keyword matching. However, a user usually gets many webpages or documents comprising the keyword but actually not relevant to the user's need. He/she must manually find the information he/she needs from the search results. Therefore, the efficacy/efficiency of keyword based searching methods is very low.

To solving the problem, this invention proposes a new method and system for question answering (QA), which facilitates users to interactively ask and answer questions on the Web. Using this method, a user can ask a pattern-based question and hope to obtain a pattern-based answer from other user(s). By doing so, he does not need to convert his question to the keywords for searching. Meanwhile, the questions and answers accumulated by the system can be used for answering automatically in the future, this is because the pattern-based questions/answers can be better understood by machines. There are some automatic QA systems, which mainly search from big corpora (e.g., the Web) to provide automatic answers to users' freetext questions but with low accuracy. There are also some user-interactive systems, such as Google Answers, Sina iAsk, Baidu zhidao, which just provide platforms for users to ask and answer questions on them. Mainly, our invented method and system are user-interactive, but also comprise functionalities of automatic answering, user modeling, automatic recommendation of questions and/or answers, and answer quality assessment, etc., based on the techniques invented.

### SUMMARY OF THE INVENTION

Basically, the invention proposes a user-interactive question answering (QA) method and system to improve the efficiency of users' asking and answering, the computer's processing accuracy of questions and/or answers, and facilitate knowledge acquisition.

The system is actually a virtual community on the Web. It encourages users to ask questions using patterns, which facilitate computer's understanding and processing of these pattern-based questions and/or answers. A user can ask a question and price it in order to encourage any user(s) to answer. On one hand, the system can accumulate the historical questions and answers and convert them into knowledge for inference for automatic and immediate answering users' questions. On the other hand, when the system cannot find the answers it needs from the historical database, it can extract the keywords of the question according to the corresponding question pattern, and then search for the relevant content on the Web using these keywords, and finally, extract the answer from the search result using the corresponding answer pattern and forward the answer to the user.

For such purposes, the invention proposes a Web-based user-interactive question answering system, comprising:

a pattern database to store and manage question patterns and/or answer patterns;

an asking unit to facilitate and process a user's asking a question using a question pattern;

an answering unit to facilitate and process a user's providing an answer using an answer pattern, wherein the said answer pattern is manually selected or created by the user, or automatically found by the answering unit from the pattern database as the one corresponding to the question pattern attached to the current question.

The said system, wherein the asking unit comprises an question pattern selection unit to let the user select a question pattern or freetext to ask the question; the answering unit comprises an answer pattern selection unit to let the user select an answer pattern or just freetext to answer the question.

The said system, further comprising a pattern creation unit to provide facilities to user to create question/answer pattern according to the predefined rules for pattern creation or generation and the predefined labels to tag the structure and the elements of the question/answer patterns.

The said system, wherein the question pattern comprises a question type and at least one blank where users should fill in with actual content; the answer pattern comprises at least one blank where users should fill in with actual content.

The said system, wherein the question/answer pattern can comprise keywords.

The said system, wherein the asking unit also comprises a pattern suggestion unit to automatically suggest the user with a list of question patterns for the user to select or confirm to use when the user asks a question in freetext, the pattern suggestion unit first analyzes the grammar of the freetext question and obtains its main structure, then finds from the pattern database a list of candidate patterns which match with the obtained main structure, and further removes from the list those candidate patterns whose blanks' semantic labels do not accord with the corresponding words/phrases in the freetext question, if there is no candidate pattern left in the list, the pattern suggestion unit automatically generates a few possible question patterns according to the obtained main structure of the freetext question and the predefined rules for pattern creation or generation and adds them to the list, finally, the question patterns remaining in the list are suggested to the user for selection or confirmation.

The said system, further comprising: a pattern management unit to be used for classification, query, management, and extension of the question/answer patterns, the said question/answer patterns are pre-stored, automatically found by the answering unit, and/or manually created by the user.

The said system, further comprising:

a historical database to store the accumulated questions, answers, and/or information about their corresponding patterns; and/or a knowledge base to store the acknowledge extracted from the accumulated questions and answers.

The said system, further comprising:

a history-based automatic answering unit to automatically provide answer(s) to a given question, the unit first finds from the historical database all the historical questions which use the same pattern used in the given question or its similar patterns, and then returns the answers of these historical questions whose filling parts for the blanks in their corresponding patterns match with the counterparts in the given question; and/or

a knowledge-based answering unit to automatically provide answer(s) to a given question, wherein the given question is analyzed and represented in predicate logic and an answer can finally obtained through inference based on the knowledge in the knowledge base; and/or

a Web-based answering unit to automatically provide answer(s) to a given question, wherein the given question and/or the keywords and the blanks in the answer pattern corresponding to the given question's question pattern are used as the queries to search on the Web using any Web search engine, and the sentences in the results of the Web search engine which match the answer pattern can be returned as answers of the given question.

The said system, wherein history-based automatic answering unit also comprises a pattern search and matching unit to find a set of patterns which are similar and relevant to a given pattern, the unit first finds those patterns that are structurally similar to the given pattern and then further filters them with the semantic labels in the given pattern and the keywords in the given pattern and the synonyms of these keywords.

The said system, further comprising an electronic commerce unit, wherein actually comprising one or more of the following units:

a question pricing unit to provide the user with facilities of pricing his/her question with a nonnegative unit of money or other incentives he/she wish to pay/give for any correct answer(s) to his question;

a pattern reward unit to reward any creator and/or user of any pattern;

a user reputation unit to evaluate the users' reputations according to their activities in the system and/or their subjective and mutual appraisal by other users;

a user survey unit to let any user to do a survey of any topic in the system with certain award/price and/or certain conditions on the potential participants. All participants can earn a portion of the award according to the conditions after the survey;

a user complaint unit to let any user raise a complaint to any other user for any fraud or other bad activities now allowed in the system;

a personal knowledge base unit to let any user to accumulate his/her personal question/answer pairs. The system automatically tries to answer any new question by searching the personal knowledge base on behalf of its owner/creator, and rewards its owner/creator if the found answer is selected by the asker as a correct answer;

a user interest/authority unit to evaluate the users' interests/authorities according to their questions/answers;

a personalized information service unit to recommend questions/answers to the users according to their interests/authorities;

an answer quality evaluation unit to evaluate the answers' qualities.

The said system, wherein the user builds/accumulates his/her personal knowledge base by answering his/her own questions in the personal knowledge base unit.

The said system, wherein the personalized information service unit comprises one or more of the following units:

a question recommendation unit to recommend a question to the users with high authorities in the area of the question;

an answer recommendation unit to recommend an answer to the users with high interest in the area of its question.

The said system, wherein the answer quality evaluation unit evaluates the quality of an answer based on one or more of the following factors: its answerer's reputation, authority, timeliness of the answer, and the hyperlinks of the references in the answer.

To achieve better the objectives of the invention, the invention also proposes a user-interactive question answering method, comprising:

Step 1, providing the asker with facilities for selecting a question pattern to ask his/her question;

Step 2, providing the answerer with facilities for selecting an answer pattern to answer a selected question;

Step 3, providing facilities for the answerer to answer the said question using the said answer pattern provided by the system in Step 2.

The said method, wherein Step 2 further comprises a step of answering the question using the answer pattern found from the pattern database by the system which is corresponding to the question pattern of the given question, or answering the question using the answer pattern selected by answerer or created by the answerer.

The said method, wherein further comprising a step for the asker to ask the question in freetext; and a step for the answerer to answer the question using either freetext or an answer pattern.

The said method, wherein further comprising a step for a user to create new question patterns and/or new answer patterns based on the predefined structures and creation rules for question patterns and/or answer patterns.

The said method, wherein the question pattern comprises a question type and at least one blank where users should fill in with actual content; the answer pattern comprises at least one blank where users should fill in with actual content.

The said method, wherein the structures of the question patterns and/or answer patterns further comprise keywords.

The said method, wherein further comprising a step of setting up a classification ontology for query, and/or management and/or extension of the classification hierarchy of the patterns and the semantic labels used in the patterns.

The said method, wherein comprising a pattern suggestion step of automatically selecting or generating a question pattern based on the freetext question when the user asks his/her question in freetext, the step actually comprising:

Step 101, analyzing the grammatical structure of the freetext question and obtaining the main structure of the sentence structure of freetext question;

Step 102, searching the pattern database using the sentence structure of the freetext question, jumping to Step 103 if the set of question patterns matching with the sentence structure of freetext question is not empty, or jumping to Step 104 otherwise (the set of question patterns matching with the sentence structure of freetext question is empty);

Step 103, from the set of question patterns obtained in Step 102, filtering out the question patterns whose blanks' semantic labels do not accord with the corresponding parts in the freetext question, and returning the remaining question patterns in the set;

Step 104, generating/creating and returning new question patterns based on the main structure of the freetext question and the predefined rules for pattern generation/creation.

The said method, wherein Step 104 further comprises a step of classifying the newly created question patterns, the step actually comprising:

Step 1801, searching the classification ontology with the query of the concept of the word/phrase in the freetext question corresponding to each blank of the newly created question pattern and finding the concept's position in the classification ontology;

Step 1802, finding the concept's position's hypernyms in the classification ontology and put the newly added question patterns into the corresponding class.

The said method, wherein further comprising a step of automatically providing answers to a user's question based on the accumulated questions and their answers in the historical database, the step actually comprising:

Step 2001, searching the pattern database using the query of the question pattern of the said question (the user's question) and finding a set of question patterns which are exactly the same as or similar to the question pattern of the said question;

Step 2002, finding from the historical database the set of previous questions using any question pattern in the set of question patterns found in Step 2001;

Step 2003, finding from WordNet or other similar synonym dictionaries the set of synonyms of the filling words/phrases of the blanks of the question pattern of the said question, and filtering out those previous questions whose filling words/phrases in the corresponding blanks are not among these synonyms;

Step 2004, returning to the user the answers of the questions remaining in the set of previous questions after filtering in Step 2003.

The said method, wherein Step 2001 further comprises:

Step 2101, searching the pattern database and finding an initial set of question patterns whose main structures are similar to the question pattern of the user's question;

Step 2102, finding from WordNet or other similar synonym dictionaries the set of synonyms of the keywords in the question pattern of the user's question;

Step 2103, filtering out those question patterns whose keywords are not among the set of synonyms found in Step 2102 from the initial set of question patterns found in Step 2101.

The said method, wherein further comprising a step of extracting knowledge represented in the form of predicate logic from the accumulated questions and their answers, accumulating the knowledge and building the knowledge base, the step of extracting knowledge actually comprising:

Step 2201, obtaining the question type, keywords and the blanks' filling parts in the question and answer(s) represented in patterns;

Step 2202, analyzing the grammars of the question and answer(s) and obtain the concepts and relationships of the keywords and the filling parts based on the classification ontology, the classification of patterns, and WordNet or other similar semantic dictionaries;

Step 2203, using predicate logic to represent the concepts and relationships obtained in Step 2202.

The said method, wherein further comprising a step of automatically providing answers to a user's question based on the knowledge base, wherein actually comprising:

Step 2301, analyzing the user's question and obtain its main structure;

Step 2302, using predicate logic to represent the concepts and relationships obtained from the user's question, trying to find any answer by making inference with predicate calculus on the knowledge in the knowledge base.

The said method, wherein further comprising a step of automatically providing answers to a user's question based on the information on the Web, wherein actually comprising:

Step 2401, using the given question and/or the keywords and/or the blanks in the answer pattern corresponding to the given question's question pattern as the queries to search on the Web using any Web search engine;

Step 2402, finding the answer sentences in the results of the Web search engine using the distance-based method, wherein comprising:

Step 2403, using the first keywords in the question pattern and/or the answer pattern as the origin of an axis, calculating the directional distances of other keywords to the origin and the number of words between them, making these distances as the standard distances;

Step 2404, for each sentence in the search results in Step 2401, first locating the position of the keyword as the origin of the axis in Step 2403, and then calculating the directional distances of other keywords to the origin keyword in the sentence, removing the sentence if any keyword's directional distance in the sentence is smaller than zero (which means the keyword is on the left hand side of the origin) or beyond a tolerance of its standard distance;

Step 2405, returning the answer sentences which accords with the standard distances in Step 2403.

The said method, wherein further comprising a step of electronic commerce, wherein actually comprising one or more of the following steps:

providing the user with facilities of pricing his/her question with a nonnegative unit of money or other incentives he/she wish to pay/give for any correct answer(s) to his question so as to encourage other users to provide timely and high quality answers;

encouraging users to ask questions using question patterns by rewarding the users' pattern-form questions;

providing facilities for any user to raise a complaint to any other user for any fraud or other bad activities not allowed in the system, wherein the complained user is panelized if he/she is verified as wrong or the complaint raiser is panelized otherwise;

providing facilities for any user to do a survey of any topic in the system with certain award/price and/or certain conditions on the potential participants, all participants can earn a portion of the award according to the conditions after the survey;

providing facilities for any user to build his/her personal knowledge base by accumulating his/her personal question/answer pairs, the system automatically tries to answer any new question by searching the personal knowledge base on behalf of its owner/creator, and rewards its owner/creator if the found answer is selected by the asker as a correct answer;

evaluating the users' interests/authorities according to their questions/answers;

a personalized information service step, comprising recommending questions/answers to the users according to their interests/authorities;

an answer quality evaluation step, evaluating the answers' qualities.

The said method, wherein the user builds his/her personal knowledge base by answering his/her own questions.

The said method, wherein the personalized information service step further comprises:

recommending a question to the users with high authorities in the area of the question; and/or

recommending an answer to the users with high interest in the area of its question.

The said method, wherein the answer quality evaluation step evaluates the quality of an answer based on one or more of the following factors: its answerer's reputation, authority, timeliness of the answer, and the hyperlinks of the references in the answer.

The said method, wherein further comprising a step of user reputation evaluation, wherein actually comprising:

Step 2601, recording and tracking the users' activities in the system;

Step 2602, analyzing the users' activities in the system to evaluate their reputations in the system;

Step 2603, providing facilities for users to rate others' reputations based on their activities;

Step 2604, calculating users' reputation values according to their reputations obtained in Step 2602 and/or Step 2603.

The said method, wherein further comprising a step of evaluating the users' reputations according to their questions and/or answers.

The said method, wherein the personalized information service step further comprises:

Step 3701, periodically calculating and storing users' interest and/or authorities in each area (knowledge domain);

Step 3702, recommending a new question to those users whose authorities in the area of the new question are higher than a threshold to answer; and/or

Step 3703, recommending a new answer to those users whose interests in the area of its question are higher than a threshold, wherein the recommended user can decide whether to accept such recommendations.

The said method, wherein the answer quality evaluation step further comprises:

Step 3801, providing the facilities for a user to set his/her quality evaluation preferences or use the system's default settings on quality evaluation of the answers to a given question, including the weights of the answerers' reputations, authorities, timeliness of the answers, and the hyperlinks of the references in the answers;

Step 3802, calculating the answers' personalized quality values based on the users' personal settings on quality evaluation preferences in Step 3801;

Step 3803, displaying the answers' quality values and/or using their quality values to sort or filter these answers.

The invention also proposes a user-interactive question answering website, wherein comprising:

a pattern database to store and manage question patterns and/or answer patterns;

an asking unit to facilitate and process a user's asking a question using a question pattern;

an answering unit to facilitate and process a user's providing an answer using an answer pattern.

The said website, wherein the answer patterns are manually selected, or manually created, or automatically found from the pattern database by the answering unit as the answer pattern corresponding to the question pattern of the current question.

The said website, wherein the asking unit further comprises an question pattern selection unit to let the user select to use freetext or a question pattern to ask his/her question.

The said website, wherein the asking unit and/or answering unit further comprises a pattern creation unit to provide facilities to the user to create question/answer pattern according to the predefined rules for pattern creation or generation and the predefined labels to tag the structure and the elements of the question/answer patterns.

The said website, wherein the asking unit also comprises a pattern suggestion unit to automatically suggest the user with a list of question patterns for the user to select or confirm to use when the user asks a question in freetext, the pattern suggestion unit first analyzes the grammar of the freetext question and obtains its main structure, then finds from the pattern database a list of candidate patterns which match with the obtained main structure, and further removes from the list those candidate patterns whose blanks' semantic labels do not accord with the corresponding words/phrases in the freetext question, if there is no candidate pattern left in the list, the pattern suggestion unit automatically generates a few possible question patterns according to the obtained main structure of the freetext question and the predefined rules for pattern creation or generation and adds them to the list finally, the question patterns remaining in the list are suggested to the user for selection or confirmation.

The said website, further comprising:

a historical database to store the accumulated questions, answers, and/or information about their corresponding patterns; and/or

a knowledge base to store the acknowledge extracted from the accumulated questions and answers.

The said website, further comprising:

a history-based automatic answering unit to automatically provide answer(s) to a given question the unit first finds from the historical database all the historical questions which use the same pattern used in the given question or its similar patterns, and then returns the answers of these historical questions whose filling parts for the blanks in their corresponding patterns match with the counterparts in the given question;

a knowledge-based answering unit to automatically provide answer(s) to a given question, wherein the given question is analyzed and represented in predicate logic and an answer can finally obtained through inference based on the knowledge in the knowledge base; and/or

a Web-based answering unit to automatically provide answer(s) to a given question, wherein the given question and/or the keywords and the blanks in the answer pattern corresponding to the given question's question pattern are used as the queries to search on the Web using any Web search engine, and the sentences in the results of the Web search engine which match the answer pattern can be returned answers of the given question.

The said website, further comprising an electronic commerce unit, wherein actually comprising one or more of the following units:

a question pricing unit to provide the user with facilities of pricing his/her question with a nonnegative unit of money or other incentives he/she wish to pay/give for any correct answer(s) to his question;

a pattern reward unit to reward any creator and/or user of any pattern;

a user reputation unit to evaluate the users' reputations according to their activities in the system and/or their subjective and mutual appraisal by other users;

a user survey unit to let any user to do a survey of any topic in the system with certain award/price and/or certain conditions on the potential participants. All participants can earn a portion of the award according to the conditions after the survey;

a user complaint unit to let any user raise a complaint to any other user for any fraud or other bad activities now allowed in the system;

a personal knowledge base unit to let any user to accumulate his/her personal question/answer pairs. The system automatically tries to answer any new question by searching the personal knowledge base on behalf of its owner/creator, and rewards its owner/creator if the found answer is selected by the asker as a correct answer;

a user interest/authority unit to evaluate the users' interests/authorities according to their questions/answers;

a personalized information service unit to recommend questions/answers to the users according to their interests/authorities;

an answer quality evaluation unit to evaluate the answers' qualities.

The said website, wherein the personalized information service unit comprises one or more of the following units:

a question recommendation unit to recommend a question to the users with high authorities in the area of the question;

an answer recommendation unit to recommend an answer to the users with high interest in the area of its question.

The said website, wherein the answer quality evaluation unit evaluates the quality of an answer based on one or more of the following factors: its answerer's reputation, authority, timeliness of the answer, and the hyperlinks of the references in the answer.

The invented method and system provide a platform for users to quickly solve their problems and share answers. This invention also improves the efficiency of users' asking and answering, the computer's processing accuracy of questions and/or answers, and facilitates knowledge acquisition. Anybody may have some urgent questions and can obtain the answers using the invented method and system.

### BRIEF DESCRIPTION OF THE DRAWINGS

FIG. 1 illustrates the workflows of users' questioning and answering using patterns in a system of an embodiment of the invention.

FIG. 2 illustrates the workflows of users' creating patterns in a system or website of an embodiment of the invention.

FIG. 3 illustrates the workflows of user reputation evaluation in a system or website of an embodiment of the invention.

### DESCRIPTION OF THE SPECIFIC EMBODIMENTS

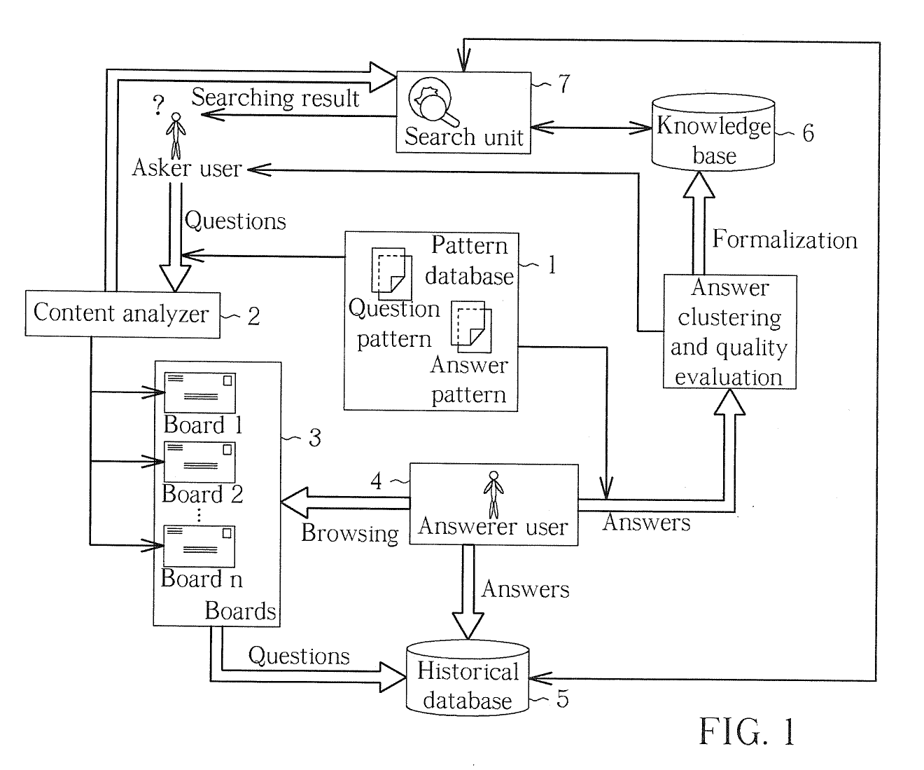

FIG. 1 illustrates the workflows of users' questioning and answering using patterns in a system of an embodiment of the user-interactive question answering method and system. As FIG. 1 shows, the procedure of users' asking and answering comprises: an asker user asks a question using a pattern, the content analyzer 2 analyzes the question's content and dispatches it to one of the boards 3 (which are containers of questions and their answers). All users can access these boards 3, and then answer these questions. An answerer user 4 answers a question using the answer pattern corresponding to the question pattern associated with the question (each answer pattern is associated with one question pattern in the pattern database 1). The system save all these questions and their answers into a database called the historical database 5, which can be used for automatic answering of questions based on the historical database. The answers to one question can be clustered into several classes, each containing similar answers. Each answer is also evaluated and shows its quality, which can help asker/readers to decide and select the correct answer(s). The high quality answers and their questions are further processed and used to extract knowledge to be stored in the knowledge base 6, which is used for automatic answering of questions based on the knowledge base. Answer clustering and answer quality evaluation can be implemented using any method available now or in the future. As FIG. 1 shows, in one specific embodiment, the system's automatic answering unit comprises: after the search unit 7 accepts the user's question, it calls history-based automatic answering unit and/or the knowledge-based answering unit to try to answer the question automatically, immediately, and accurately. The knowledge-based answering unit does searching and reasoning based on the analyzed question in the knowledge base to obtain answer(s). The history-based automatic answering unit searches in the historical database for similar question(s) to the given question and returns the answers corresponding to these similar question(s).

In one embodiment of the invention, the method and system can be applied in the education systems, such as for schools, as an extension of the education-oriented BBS systems, in which teachers and students can conveniently communicate with one another after class/school. Many boards corresponding to the subjects and sub-subjects can be set up initially in the system. These boards can be adjusted and more can be added in the future. A user usually selects a board to host the question he wants to ask before he asks. If he does not select a board, system can automatically categorize the question into a suitable board according to the classification ontology and/or the question's semantic information. A user can ask the question using a pattern or freetext. The system encourages users to ask questions using pattern by rewarding them with some incentives (see the electronic commerce unit). When a user wants to ask a question using a pattern, he needs to select the question pattern from its class/category. The system comprises a pattern database, which organizes the question patterns in various classes, including Location, Numeric, etc. For one example, the user can select sub-class City in class Location when he wants to ask for the position of a city. Location denotes a position, and has some sub-classes, such as Country, City, etc. Hence, the user can select a corresponding class according to his actual question. For another example, the user can select sub-class Date in class Numeric when he want to ask for somebody's birthday; the system can also automatically suggest a few relevant patterns and fill in their blanks according to the user's freetext question, and list them under the original question, for the asker user to directly select one pattern, modify its blanks' content if necessary, and then submit his question in the selected pattern form.

After the user selects a question pattern, the system will generate the question pattern's blank(s) automatically according to the pattern. The user only needs to fill in the blank(s) in the pattern with corresponding content, and the actual question can be generated before submitted.

The following is a concrete example:

Suppose user A wants to ask the question: “What is the color of rose?” He can select to ask the question using freetext or a pattern. The procedure of asking the question using freetext comprises:

1) The user logs on the system and opens the page for asking a question;

2) The user fills in the question content (“What is the color of rose?”) in the question box (a textbox) directly using a nature language freetext, i.e., he inputs the whole content of the question into the same textbox;

3) The user fills in other options of the question, such as expiry time and the price;

4) The user submits the question.

The procedure of manually selecting a pattern for asking the question comprises:

1) The user logs on the system and selects the “Use Pattern to Ask” function;

2) The user fills in the question content using a pattern, further comprising the following three steps:

Step 1: The user selects a suitable class of question patterns, e.g., the class “Entity\Plant”.

Step 2: The user selects a suitable pattern from the current list in “Entity\Plant”, e.g., “What is the color of [Entity\Plant]?”

Step 3: The system generates the blank(s) according to the Place-holder(s) (i.e., [Entity\Plant]) in the selected question pattern, in the format as follows:

What is the color of

[symbol]

wherein, the part in the box (textbox) denotes the blank (or place-holder) in which the user can fill with certain text content, and the label “Entity\Plant” in the box is a semantic label used to explain and restrict the text content for the blank. The user should fill in the blank(s) according to his question and the restriction of the semantic labels. In this case, he should fill in “rose” and the question becomes “What is the color of rose?”. All blanks should be handled similarly;

3) The user fills in other options, such as expiry time and the price;

4) The user submits the question.

The procedure of using the patterns suggested by the system to ask a question comprises:

1) The user logs on the system and opens the page for asking a question;

2) The user fills in the question content (“What is the color of rose?”) in the question box (a textbox) directly using a nature language freetext, i.e., he inputs the whole content of the question into the same textbox;

3) The user fills in other options of the question, such as expiry time and the price;

4) The user enters into the question preview page which displays the original question on a top position and a few suggested patterns under it. These suggested patterns are selected by the system, which match with the original question. The system also automatically fill in their blanks according to the user's freetext question for the asker user to directly select one pattern and modify its blanks' content if necessary. 5) The user submits his question in the selected pattern form.

When a user answers a question, the system finds the answer pattern which corresponds to the question pattern of the current question, and then generates the blank(s) in the answer pattern for the user to fill in, wherein, the correspondence relationship between a pair of question pattern and answer pattern is also stored in the pattern database of the system.

Suppose User B wants to answer “Red” to User A's question “What is the color of color?” in this embodiment.

1. If the question is asked using freetext, User B can also answer it in free text of nature language in the follow steps:

1) User B logs on the system, selects this question and opens its page, and then clicks the “Reply” button;

2) User B directly fills in the complete answer in nature language “The color is red” in the textbox;

3) User B submits the answer and completes the answering procedure.

2. If the question is asked using a pattern, the answering procedure comprises the following steps:

1) User B logs on the system, selects this question and opens its page, and then clicks the “Reply” button;

2) The system find from the pattern database the answer pattern corresponding to the question pattern User A used to ask this question, wherein the found answer pattern is “The <K>color</K>is [Entity\Color]” in this embodiment;

3) The system generates the answer and its blank in the form “The color is [symbol] ?” according to the answer pattern and its place-holder;

4) User B fills in the blanks, i.e., fills in “red” at the position of [symbol] , and the full answer becomes “The color is red.”

5) User B submits the answer and completes the answering procedure.

Using patterns can improve the efficiency of asking and answering. A user can select a question class conveniently, and the corresponding question with certain blank(s) is generated according to the question pattern. He/she does not need to fill in the whole question as in traditional Question Answering systems. Hence, it improves the efficiency of asking.

In an embodiment, the invented method and system defines some labels and predefined rules for manual pattern creation and automatic pattern generation. The system also provides a tool called the pattern creation guide for users to use for creating patterns manually. This invention proposes two types of patterns: structural pattern and semantic pattern. The structural pattern is generated based on grammar structure, and the semantic pattern adds certain semantic labels to the structure pattern. In summary, a question pattern is a generalization of a class of questions with similar grammar structure and/or relevant semantics (or similar semantic labels).

A question pattern comprises 3 parts, which are question type, keyword(s) and at least one blank(s) respectively, wherein the keyword(s) are optional. Question type denotes the interrogative word and grammar type of the question, such as when, what, where, who, which, why, how, and how+adj/adv, such as how much, how old, etc. The system uses “<Q>Type</Q>” to denote a question type, wherein <Q> is question type label. A keyword is one of the main words in the question and each is labeled by “<K>Keyword</K>”, wherein <K> is keyword label. A blank in a pattern is the replaceable part or position, which can be filled in with various content to make it an actual question. A blank is also called a place-holder and denoted by “[Place-holder]”. A blank should also be labeled by the semantic type of the content used to fill in the blank. For examples, the semantic type for labeling the blanks can include Plant, Date, Location, Definition, etc. Meanwhile, the system defines a set of corresponding rules for the patterns, wherein mainly comprising but not limited to: each label for the question type, each keyword, and each blank uses a pair of tags to mark its beginning position and its end position, respectively; a pair of tags for a label cannot appear in another pair of tags; there can be more than one keyword. Following these rules and labels, users can generate question/answer patterns. For example, for the question “What is the color of rose?”, its corresponding question type is What, color is the keyword, rose is the position of the blank, which is labeled as Entity/Plant, hence its question pattern is: <Q>What</Q> is the <K>color</K> of [Entity/Plant]? An answer pattern comprises two parts, which are keyword(s) and at least one blank(s), whose representations are the same as those in the question pattern. The keyword(s) in an answer pattern are also optional since the object to answer or the question target is known from its question. For example, for the answer “The color is red,” its corresponding keyword is color, red is the position of the blank, and its corresponding answer pattern is: The <K>color</K>is [Entity/Color]. Because from the question, the object to answer (or question target) is known as “The color of rose”, the answer pattern can be simplified to be just one blank [Entity/Color].

The initial system can provide some frequently-used question patterns and their answer patterns well categorized in the pattern database. A user should first select a corresponding pattern before asking a question. If there is not such corresponding pattern, the user can create a new suitable pattern using the pattern creation guide tool. Meanwhile, the user can also specify the style and structure of the answer corresponding to the question by selecting or creating the answer pattern manually. Using the answer pattern, the system can generate corresponding blank(s) automatically when other users answer the question. The answers obtained by letting the users just fill in the blank(s) are more normative and meeting the askers' requirements.

In one embodiment of the invention, the method and system comprise a method for pattern searching and matching, which can find from the pattern database a set of similar patterns to a given pattern. The said method for pattern searching and matching comprises: for a given pattern, which can be either a question pattern or an answer pattern, the method or system searches the pattern database for those patterns which are similar to the given pattern in their main structure and obtain the initial pattern set; obtains from WordNet the synonyms of the keyword(s) of the given pattern; filters out from the initial pattern set those patterns whose keyword(s) are not the keyword(s) or its/their synonyms; and returns the remaining patterns in the initial pattern set. For example, for a given pattern “<Q>What</Q> is <K>character </K> of a [Human\Individual]?”, the procedure of pattern searching and matching comprises the following steps:

1. for the given pattern, obtaining its main structure, wherein further comprises:

1) obtaining the question type using question type label <Q>and </Q>;

2) obtaining the keyword “character” using the keyword label <K>and </K>, obtaining the semantic label “Entity\Individual” of the place-holder [Entity\Individual];

3) forming the basic structure of the pattern: <Q>What</Q> XX <K>character</K> XX [Entity\Individual]?, wherein XX denotes any text string.

2. searching for synonyms of keyword “character” in WordNet and obtaining the synonym set {nature, attribute, peculiarity, feature, trait};

3. generating various pattern structures using any word in the synonym set, such as “<Q>What</Q> XX <K>nature</K>XX[Entity\Individual]?”, “<Q>What</Q> XX <K>attribute</K>XX[Entity\Individual]?”, etc.

4. searching and matching all the pattern structures in step 3 in the pattern database. If a pattern “<Q>What</Q> is <K>character</K>of a [Entity\Individual]?” is found, it will be returned directly. Otherwise, if any pattern whose structure is similar to any of the pattern structures generated in step 3, such as, “<Q>What</Q> XX <K>nature</K>XX[Entity\Individual]?”, is found in the pattern database, it will be returned. Otherwise, NULL will be returned.

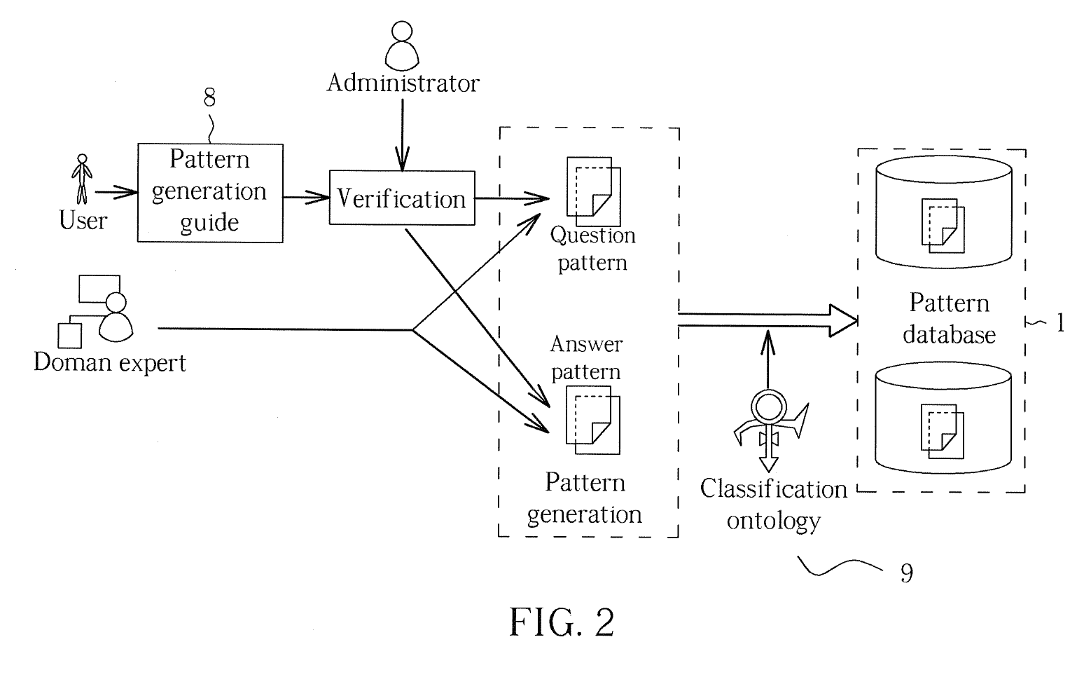

In one embodiment of the invention, the system and its method has the function of pattern suggestion. FIG. 2 is the workflow of users' creating patterns in a system or website of an embodiment of the invention. A normal user can create question/answer patterns using the pattern creation guide tool 8. The question/answer patterns created by normal users will be verified by administrator(s). The expert users of any field can create question/answers pattern directly. The verified question/answers patterns are associated into pairs, and categorized using the classification ontology 9, and stored in the pattern database 1. The procedure of pattern creation is as follows:

A user can ask a question in freetext. The system firstly analyzes the grammar structure of the freetext question and obtains its main structure, and then obtains a set of matched patterns by searching in the pattern database using the obtained main structure. Then, the system analyzes the semantic information of the blanks' semantic labels of the matched patterns and filters those irrelevant patterns whose blanks' semantic labels do not accord with the counterparts in the given freetext question, and finally returns the best relevant patterns to the user. If there is no relevant pattern found in the pattern database, the system can automatically generate new pattern(s) using pattern generation rules and the obtained main structure. In one embodiment of the invention, when a user asks a question “What is the character of a priest?” in freetext, the system automatically suggest a few question patterns, which are structurally similar and semantically relevant to the user's question, in the following steps:

1. Analyzing the grammar of the freetext question “What is the character of a priest?”;

2. Analyzing and obtaining the interrogative word “What” and use it as the question type;

3. Analyzing and obtaining the keywords “priest” and its modifier “character”, obtaining the hypernym of “priest” according to the domain ontology, i.e., obtaining the relationship Is-A(priest, Individual), wherein the meaning is that priest is an individual.

4. Generating the main pattern structure: <Q>What</Q> XX <K>character</K> XX [Entity\Individual]?, wherein XX denotes any text string;

5. Obtaining the set of similar patterns to the main pattern structure obtained in Step 4 using the method for pattern searching and matching. The system returns the set of similar patterns to the user, and then goes to step 7, if it is not NULL; otherwise no similar pattern can be found in the pattern database, and the system then goes to step 6;

6. Replace “XX” in the main pattern structure in the step 4 with the counterpart in the freetext question, for example, in <Q>What</Q> XX <K>character</K>, “XX” should be “is”, then the new pattern is generated as: <Q>What</Q> is the <K>character</K>of a [Entity\Individual]? and returned to the user;

7. The user selects the most suitable pattern, for example, “<Q>What</Q> is the <K>character</K>of a [Entity\Individual]?”.

If the system generates a new pattern, the generated pattern should be categorized into a corresponding class for better searching and management. The system has a classification ontology to be used for query, management of the patterns, and extension of the classification hierarchy of the semantic labels and the patterns;

Initially, we build in the system a classification ontology for patterns and their semantic labels according to all the concepts at all hierarchical levels.

When a new pattern is generated, the system uses the concept(s) corresponding to the content of the blank(s) (usually, these concepts are the semantic labels of the blanks) as a query to search in the classification ontology, obtain the concept's hierarchical position and its hypernyms in the classification ontology, and then categorize the pattern into the corresponding class determined by the concept's hierarchical position and its hypernyms. For example, if the concept corresponding to the content of the blank is Flower, its hypernym is Plant, and Plant's hypernym is Entity, hence the pattern is categorized into the class of “Entity\Plant”.

In one embodiment of the invention, the method and system can automatically answer a user's question using the method for pattern searching and matching and the method of pattern suggestion. The detail procedure comprises the following three parts:

(I) history-based automatic answering

After a period of running, the system accumulates a lot of questions and corresponding answers, which form the historical database, including the information of corresponding patterns used in these questions/answers. When a user submits a new question, the system searches the pattern database for the set of similar question patterns which have the same or similar structure of the corresponding question pattern of the given question using the method for pattern searching and matching, and then searches the historical database for the set of historical questions which use any pattern in the the set of similar question patterns. The set of found historical questions are filtered using the words/phrases filled in the blank(s) for the new question and their synonyms. The remaining questions in the set of historical questions are therefore similar to the new question and their answers are returned to the user as answers to the new question.

For the example of the user's question “What is the character of a priest?” the system can search for the question from the historical database and return its answer to the user. According to the ways of questioning, there are two cases for history-based automatic answering:

Case 1: The question is asked using freetext:

1. Obtaining the pattern of the question using the method for pattern suggestion.

2. Obtaining the set of similar question patterns in the pattern database using the said method for pattern searching and matching.

3. Obtaining from the historical database the set of historical questions that use any pattern in the set of similar question patterns.

4. Obtaining the blank's corresponding content “priest” and its synonyms in the WordNet, which are {clergyman, reverend, clergy, pastor, vicar, father}, and remove any question in the set of historical questions whose corresponding blank's content is not “priest” or any of its of synonyms. The remaining questions form the set of similar questions.

5. Obtaining the answers of all questions in the set of similar questions from the historical database and returning these answers as the answers to the user's new question.

Case 2: The question is asked using a pattern:

1. The pattern of the new question is obtained directly, which is supposed to be: <Q>What</Q> is <K>character</K>of [Human\Individual]?

The other steps (Step 2-Step 5) are the same as Case 1.

(II) knowledge-based automatic answering

The system builds a knowledge base of knowledge extracted from the historical questions and their high quality answers. The knowledge base is the core of intelligent search. However, because it costs a long time to build the knowledge base, the system mainly searches the historical database for automatic answering at the beginning stage of its running.

The system first analyses the question and obtains its main structure, which is then represented in predicate logic. An answer can finally be obtained through inference based on the knowledge in the knowledge base

(III) Web-based automatic answering

For a question a user submits, if the above two methods failed, the system will search on the Web for answers. When a user asks a question, he can select a question pattern or just use freetext. If the question is asked using freetext, the system will analyze and obtain the question pattern using the above method for pattern suggestion. And then the system searches answers based on the historical database. If it fails, it will generate a corresponding answer pattern using the above answer pattern generation automatically (it can also be specified by the user), search on the Web using the keywords and the content of the blanks corresponding to the answer pattern as queries, and then filter the results using the following distance-based method.

For the question “What is the color of rose?” a user submits, in one embodiment of the invention, if the user-interactive question answering system cannot find answers from the historical database and/or the knowledge base, it will search on the Web for answers, wherein further comprising the following steps:

1. Obtaining the question's pattern as follows:

<Q>What</Q>is the <K>color</K> of [Entity\Plant]?, wherein, it is selected by the user when he/her asks or generated by the system.

2. Obtaining the answer pattern according to the relationship between question pattern and answer pattern: The <K>color</K> of <K>rose</K> is [Entity\Color].

3 Analyzing and obtaining answer pattern's keywords: color, rose and any possible instance for the blank [Entity\Color], such as red, blue, yellow, etc.

4. Searching on the Web using the content obtained in Step 3 as queries and obtaining the search results.

5. Filtering the results using the distance-based method.

6. Returning to the user the search results after filtering in Step 5.

Wherein the distance-based method is: For an answer pattern, it analyzes its main structure and builds the coordinate axis along the pattern using the first keyword as the origin, and calculates the standard distance between every keyword and the origin using each term as the standard unit. In the procedure of filtering, it firstly finds the keyword of the origin and then calculates the distance between every keyword and the origin. If the distance is less than zero, the answer will be ignored; otherwise, it will be compared to the standard distance. Finally, the answers satisfying the standard distances will be returned to the user. There is an important parameter: the distance threshold, which is the difference between a keyword's distance in the result and the standard distance. The user or the system can set a distance threshold. If the difference is less than the threshold, the answer is acceptable; otherwise, the answer is not.

The procedure of filtering uses the standard distances as references and returns the results with similar structure. The actual algorithm is as follows:

1) Compute the standard distance of all keyword K[i] in the answer template and represent them as SD[i] (i=0,1, . . . , N−1) (N=number of keywords and SD[0]=0 for the first keyword K[0] since it is used as the origin);

2) Extend all possible values of concept corresponding to Place-holder;

3) Keywords searching in Web, it will return result pages;

4) Define threshold U;

5) Algorithm of filtering:

Set R empty;
Foreach Sentence S(on the search result pages)
{

Find the position of K[0] in S and use it as the origin for S;
For(i=1; i<N; i++)//Foreach Keywords X in S;
{

Distance(X)=distance of X to K[0] in S;
if(Distance(X)<0)||(Abs(Distance(X)-SD[i])>U)
break;

}
If(i<N)

Continue;

(E.g., S=”The color of Chinese rose is light blue”, the keywords'
distances

are color(0), rose(3), blue(6), which are all in allowed tolerance, so S
can be used as an answer)

R=R union S

}

6) Return R to user

The following is the explanation of the above algorithm:

wherein the answer pattern is “The <K>color</K> of <K>rose</K> is [Entity\Color].” and its distances are calculated in the following steps.

1. Analyzing its main structure and building a coordinate axis using keyword “color” as the origin. Each term is used as a distance unit (1), and the label of each blank (place-holder), e.g., [Entity\Color] is also used as a keyword;

2. Calculating every keyword's coordinate, which is the distance to the origin and used as standard distance: color(0), rose(2), [Entity\Color](4);

3. Searching on the Web using the three keywords (and any expansion of each blank's label, e.g., black, white, red, blue, yellow, green, etc. for [Entity\Color], for example, we can search with color, rose, and red) and obtaining the results containing these three keywords.

4. Setting the distance threshold U=2 for the difference between a keyword's distance in the results to the origin and the standard distance. The description of the algorithm is as follows:

Setting R as NULL, which is the result set returned to users. For every sentence S in the result, finding its first keyword K[1] (color) as origin. For the other two keywords, calculating their distances to the origin separately, which will be compared to standard distance. For the sentence “The beautiful color of Chinese rose is light red”, color is origin, keyword rose's distance to color is 3, standard distance is 2, so their difference is 1, which is less than threshold 2; keyword red's distance to color is 6, standard distance is 4, so their difference is 2, which is also less than threshold 2, so that the sentence is acceptable and can be saved into R.

5. Returning R to users. If R is NULL, that means there is no acceptable result.

In one embodiment of the invention, there is a function of C2C (customer to customer) electronic commerce for users, which further comprising one of more of the following steps:

A question pricing step, which is something like inviting public bidding for knowledge or answers. When a user asks a question, he/she prices the question with some money (virtual or real money) from his account, which will be paid to a user who gives the right answer after deducting a commission fee (e.g., 20%). In this step, the system can also charge the asker user a certain amount (e.g., 0.1K$/day) for his question before it is closed;

An e-survey step, which allows a user to set some conditions for other users who want to participate in the e-survey (for example, gender must be female) and a total amount of reward. When the survey is closed, the reward will be distributed to all participants according to certain rules, for example, proportional or average distribution according to the time sequence of the participants' answers and/or their reputations. The system can return two types of statistical results, one is the ordinary result based on the number of participating users, and the other is the result based on the users' reputations, the latter can filter out some vicious or meaningless answers and is therefore more precise;

A user complaint step, if the asker user does not distribute the offered money to the first answerer(s) who provide correct answer(s) or the asker user has some cheating behavior, the “victim” can complaint in the complaining period. Administrator will investigate and process the complaint. In addition, the wrong party in the complaint will be punished, for example, by decreasing his reputation;

A pattern reward step, when users ask questions using patterns, the system will return some from the offered money and/or the commission fee to them in order to reward their asking using patterns; and/or the system can also take some from the offered money and/or the commission fee to reward the creator of the used pattern;

A personal knowledge base step to allow the users to build their personal knowledge bases and try to answer any new question by searching these personal knowledge bases. Once an answer is found, the system automatically answers the new question on behalf of the owner(s) of the personal knowledge base and reward the owner(s) if the answer(s) are selected by the asker as correct.

The electronic commerce step in one embodiment further comprises one or more of the following steps:

A step of evaluating the users' interests/authorities according to their questions/answers; The system analyzes a user's activities in each board, including but not limited to the number of his questions, the number of his answers, and/or the ratio of his correct answers, to evaluate the user's interest and/or authority in the area corresponding to the board;

a personalized information service step, comprising recommending questions/answers to the users according to their interests/authorities;

an answer quality evaluation step, evaluating an answer's quality according to its answerer's reputation, and/or authority, and/or the timeliness, and/or the hyperlinks in the references of the answer, and/or other pre-defined evidence or factors.

Wherein the question pricing step further comprising:

Step 1. A user asks a question and prices it with a certain amount of money, which will be deducted from his/her account and saved to the system cache account. The pricing money must be no more than the money of his/her account;

Step 2. Other users can answer the question;

Step 3. If there is a correct answer, the asker user can close the question and other users cannot answer the question any more. The asker user can select one or more answers as correct answer(s) according to certain rules and specify the proportion of money distribution among the correct answerer(s). The system will pay the offered (pricing) money in the system's cache account to the corresponding correct answerer(s) according to the proportion after the complaint period; the rules for selecting correct answer(s) are, selecting the earliest correct answer, and if there is no answer containing all correct answer(s), selecting some earlier correct answers according to their answering time; and if the asker user considers that there is no correct answer, he can select no answer and the pricing money will be returned to him/her.

Step 4. The asker user should specify an expiry time for his question, if there is no correct answer after the expiry time or the asker user cancels the question before there is no correct answer provided, the pricing money will be returned to the asker user.

Wherein the user complaint step further comprising:

Step 1. Once the asker user closes the question, the pricing money in the cache account will be distributed after the complaint period, instead of immediately. In the complaint period, any user can complaint the asker user for any of the asker user's cheating or unfair behavior(s);

Step 2. An administrator will verify each complaint, if the complaint is correct, the asker user will be punished and the pricing money will be redistributed accordingly; otherwise, the complainer will be punished (cf. the user reputation unit);

Step 3. The pricing money will be distributed to corresponding users after the complaint period.

Wherein the personalized information service step comprises:

Step 1, periodically computing and storing the users' interests/authorities in all boards.

Step 2, recommending a new question to those users whose authorities in the area of the new question are higher than a threshold and/or are among top N authorities in the area (wherein the threshold and N are predefined) to ensure each new question be answered with timely and high quality answers; and/or

Step 3, recommending a new answer to those users whose interests in the area of its question are higher than a threshold, wherein the recommended user can decide whether to accept such recommendations;

wherein the answer quality evaluation step further comprises:

Step 1, providing the facilities for a user to set his/her quality evaluation preferences or use the system's default settings on quality evaluation of the answers to a given question, including the weights of the answerers' reputations, authorities, timeliness of the answers, and the hyperlinks of the references in the answers; in one embodiment, these weights can be set according to their impacts to the answer quality, such as, 0.2, 0.5, 0.1, 0.2 for these four factors respectively in this sequence, which means the impact of authority to answer quality is the biggest among the four factors.

Step 2, calculating the answers' personalized quality values based on the users' personal settings on quality evaluation preferences;

Step 3, displaying the answers' quality values and/or using their quality values to sort or filter these answers for displaying, such personalized display can help the user find his interesting answer easily;

In one embodiment of the invention, the system and its method can be used as a collaborative approach to collect all users to acquire, accumulate, transform knowledge and build the knowledge base, wherein further comprising:
(1) Encouraging questioning and answering among users using the C2C electronic commerce model and to obtain and accumulate corresponding knowledge represented in pattern-form question/answer pairs;
(2) Transform the knowledge represented in pattern-form question/answer pairs to the formal predicate form knowledge, wherein the transformation method comprising:
a) For a pair of pattern-based question and answer, the system first analyzes their patterns: (i) obtaining the question type by finding the “<Q>” label; (ii) Obtaining the keywords of the question and answer by finding the “<K>” labels; (iii) Obtaining the filling contents and their semantic labels of the blanks by finding the “[]” labels.
b) The system then analyzes the grammars of the questions and answers, and then analyzes the relationships (e.g., “of”) between the keywords and the blanks according to the pattern's class, classification ontology and semantic dictionary. The system represents these relationships and the concepts using predicate logic. Such knowledge represented with predicate logic accumulates and forms the knowledge base.

In details, given the question pattern: <Q>What</Q> is the <K>color</K> of a [Entity\Plant]? the question: What is the color of a rose? and the corresponding answer pattern: The <K>color</K> of <K>rose</K> is [Entity\Color], and the answer: The color of rose is red, the procedure is as follows.

1. Obtaining the parts of question pattern as following:

1) Analyzing and obtaining the question type “What”;

2) Analyzing and obtaining the keywords “color”;

3) Analyzing and obtaining the blanks “rose”, whose concept class is its semantic label [Entity\Plant].

2. The system analyzes the grammar of the question and answer and obtains the knowledge, wherein further comprising:

1) According to the concept class corresponding to the semantic label of the blank, obtains the relationship: Rose is a Plant. There is a relationship of Is_A, which can be represented in Is_A(Rose, Plant), transformed into the knowledge frame representation as follows:

Defframe Rose
{
Is_A: Plant
}

2) Analyzing the grammar of “color of rose”, we know color is one of rose's attributes. So it can be represented as Rose (Have_attribute: color). According to the attribute red, it can be represented in Concept_Attribute_Value (Rose, Color, Red), and transformed into knowledge frame representation as follows:

Defframe Rose
{
Color: Red
}

3. Integrating the knowledge frame obtained in Step 1 and 2, we can obtain the following knowledge:

Defframe Rose
{
Is_A: Plant
Color: Red
}

In one embodiment of the invention, the method further comprises a step of user modeling and applications, wherein further comprising one or more of the following:

(1) User interest modeling: the interest of a user is a list of names of boards and their corresponding weights (or frequency). When the user asks a question in a board, the weight of the board will be increased by 1. A user can add some boards to their Favorite Board list manually and these boards' weights are set as the highest initially, such as 100 (when other boards' weights will not increase further after they reach 100). The system can automatically recommend questions/answers and/or evaluate answers' qualities according to the users' interests/authorities;

(2) User authority modeling: the authority (or ability or level of knowledge) of a user is also a list of names of boards and their corresponding weights (or frequency). When the user answers a question in a board and the answer is accepted as a correct answer (see the electronic commerce unit), the weight of the board is increased by 1. The system can automatically recommend questions/answers and/or evaluate answers' qualities according to the users' interests/authorities.

(3) User reputation modeling: a user's reputation is a number calculated using the following steps:

Step 1. User behavior tracking, recording the users' historical behaviors in the system, which are related to users' reputations and include but are not limited to the following behaviors: login, browsing questions/answers, searching, asking, answering, mutual rating or appraisals, using patterns, etc.

Step 2. User behavior analysis. Because the users' reputations are reflected by their interactive behaviors, the user reputation unit builds a social network model to reflect the interactive relationships among the users and analyze these relationships. The interactive relationship between two users can be either of the following two types: direct relationship and indirect relationship. A change in any node (a user) in the social network is propagated to a limited range in the network to reflect the impact of these two types of relationships to calculation of other users' reputations (on other nodes).

Step 3. User's mutual ratings (or appraisals), wherein further comprises users' complaints to certain behaviors (for example, a user didn't select correct answer according to the rules, cf. the user complaint step) and/or users' supports to certain answers while browsing other users' answers, and/or the asker users' selecting correct answers.

Step 4. Online reputation computing, which computes the users' overall reputation values according to the user reputation value obtained in the user behavior analysis step (step 2) and the user reputation value obtained in the user's mutual ratings step (step 3), for example, the overall reputation value of a user can be the weighted average of his reputation values obtained in the user behavior analysis step and the user's mutual ratings step.

Step 5. User reputation feedback, which displays a user reputation value besides his/her question/answer to remind other users ,who can determine the interactive manner with such user according to his/her reputation and/or their own experience with such user. The system can also reward or punish the users according to their corresponding reputations.

In one embodiment of the invention, the system is used to answer users' questions, wherein further comprising:

A pattern management unit, which is used for administrators and/or users to classify, search, manage and/or extend the semantic labels and the patterns which are pre-stored in the pattern database, and/or generated automatically by system, and/or created manually by users;

An asking unit, which is used for users to ask questions using freetext or patterns;

An answering unit, which is used to provide answers to askers, wherein the answers can be provided by users by filling in the blank(s) of the answer patterns which are provided automatically by the system according to the questions, or the answers can also be provided and evaluated automatically by the system, wherein automatic answering. further comprises: (I) history-based answering unit, which is used to provide the high quality answers of the accumulated questions in the historical database which are the same or similar to the new question; (II) knowledge-based answering unit, which is used to answer questions using the knowledge base efficiently and accurately; (III) Web-based answering unit, which is used to search on the Web and select those high quality answers to users' questions;

A knowledge conversion unit to convert the knowledge represented in the pattern-form question/answer pairs to the formalized predicate-form knowledge;

An electronic commerce unit, which is used to encourage users to answer by pricing the questions and ask question using patterns by rewarding them, and punish users who have been correctly complained.

The electronic commerce unit further comprising one or more of the following units:

A question pricing unit, which is used for a user to price his question to offer reward users who can answer the question correctly;

A pattern reward unit, which is used to reward users and/or creators of patterns;

A user reputation unit, which is used to evaluate users' reputations based on recording and analyzing the users' behaviors and/or users' mutual ratings/appraisals on their reputations;

An e-survey unit, which is used for any user to do a survey in the system by setting certain conditions for participants and a total amount of reward. When the survey is closed, the reward will be distributed to all participants according to certain rules;

a user complaint unit to let any user raise a complaint to any other user for any fraud or other bad activities now allowed in the system;

a personal knowledge base unit to let any user accumulate his/her personal question/answer pairs. The system automatically tries to answer any new question by searching the personal knowledge base on behalf of its owner/creator, and rewards its owner/creator if the found answer is selected by the asker as a correct answer;

a user interest/authority unit to evaluate the users' interests/authorities according to their questions/answers;

a personalized information service unit to do personalized information recommendation, such as recommending a question to those users with high authorities in the corresponding area and/or recommending an answer to those users which high interests;

an answer quality evaluation unit to evaluate an answer's quality according to its answerer's reputation, and/or authority, and/or the timeliness, and/or the hyperlinks in the reference of the answer, and/or other pre-defined evidence or factors. wherein, user interest/authority unit, personalized information service unit, and/or the answer quality evaluation unit can be used to automatically evaluate users' interests and/or authorities (knowledge level), and/or answers' qualities, for the system to recommend a question to high authority users, recommend an answer to high interest users, help users to judge the credibility of other users' activities, reward users who have contributions and punish vicious users.

The invention proposes a question answering website, wherein further comprising:

A user management unit to provide functions including user registration, login, identity validation, information management, authentication, etc;

A pattern management unit, which is used for administrators and/or users to classify, search, manage and/or extend the semantic labels and the patterns which are pre-stored in the pattern database, and/or generated automatically by system, and/or created manually by users;

An asking unit, which is used for users to ask questions using freetext or patterns.

An answering unit, which is used to provide answers to askers, wherein the answers can be provided by users by filling in the blank(s) of the answer patterns which are provided automatically by the system according to the questions, or the answers can also be provided and evaluated automatically by the system, wherein automatic answering. further comprises: (I) history-based answering unit, which is used to provide the high quality answers of the accumulated questions in the historical database which are the same or similar to the new question; (II) knowledge-based answering unit, which is used to answer questions using the knowledge base efficiently and accurately; (III) Web-based answering unit, which is used to search on the Web and select those high quality answers to users' questions.

A knowledge conversion unit to convert the knowledge represented in the pattern-form question/answer pairs to the formalized predicate-form knowledge;

An electronic commerce unit, which is used to encourage users to answer by pricing the questions and ask question using patterns by rewarding them, and punish users who have been correctly complained.

The electronic commerce unit is the same as previously described, which can include one or more of the following units: a question pricing unit, a pattern reward unit, a user reputation unit, an e-survey unit, a user complaint unit, a personal knowledge base unit, a user interest/authority unit, a personalized information service unit, an answer quality evaluation unit. The functions of these units are the same as previously described and will not be described in more details here.

In one embodiment of the invention, the web-based questioning and answering system comprises a user management unit to mange users' activities, a unit generating question patterns and corresponding answer patterns, a user asking unit, a user answering unit, an answer quality evaluation unit estimating users' answers' qualities. The system can be implemented on a company's server or an agency's server. Before using the system, a user should register first. Registered users can ask question using suitable pattern and be rewarded for answering other users' questions. There are two ways of answering, one is supporting any other user's answer, and the other is filling in a correct answer.

In one embodiment of the invention, the system or website comprises the function for multiple users to ask and answer questions using patterns, wherein users can create question patterns and answer patterns manually according to certain rules; the patterns can be selected, generated and classified according to users' questions, which can also be answered automatically using the technique of pattern searching and matching; questioners should distribute the reward to users who answered correctly after there are one or more correct or satisfactory answers. The website evaluates all users' reputations according to their online behaviors.

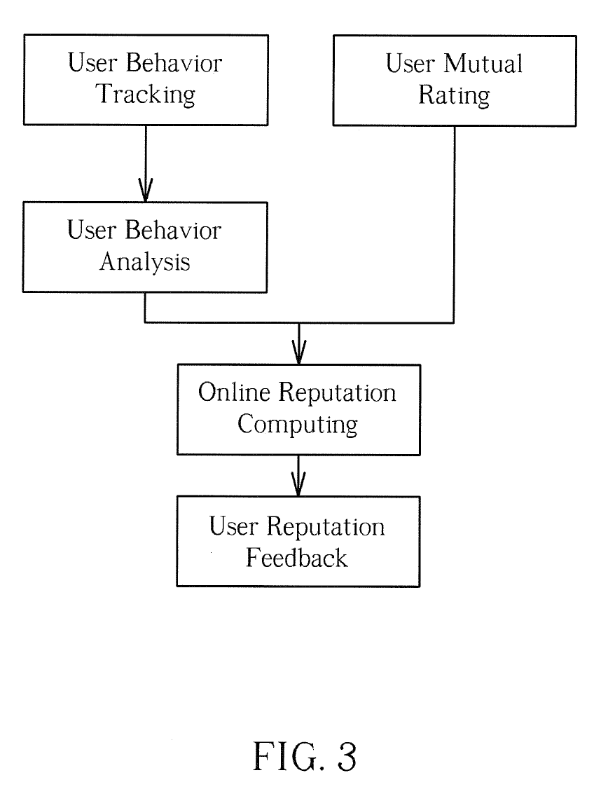

FIG. 3 shows the workflow of the online user reputation system. Before computing the users' reputations, the users' activities related to their reputations will be tracked and recorded, which form their historical activity data. The user's reputations can be evaluated by analyzing the aspects and extents of the impacts of the different activities of these users. Users are also encouraged to rate/appraise others' reputations. Such ratings/appraisals also include the evaluations or supports of certain answers. The reputation data obtained using the above two methods are combined together as the overall reputations of users in the online reputation computing engine according to their impacts. These obtained reputations are provided as feedback to the system in order to enhance the function of online reputation system. For example, a user's reputation value is displayed besides his/her question/answer to remind other users, who can determine the interactive manner with such user according to his/her reputation and/or their own experience with such user. The system can also reward or punish the users according to their corresponding reputations.

The invented method and system have wide applications, which provide a platform for users to quickly solve their problems and share answers. Anybody may have some urgent questions and can obtain the answers using the invented method and system. Anybody can log on the invented system to ask or answer questions on the Web and do not need to install any software on the client side, so it will not bring any overload to any user. Meanwhile, enterprise users can also use the invented method and system to provide technical supports or consultancy services to their clients, employee training, and surveys, or use it as a tool for knowledge acquisition. Schools can use it as an education assistance system to enhance students' communication after class. Anyway, the invented method and system can be widely used in all services related to knowledge and information. The system itself is also a good application providing knowledge and information services.

### CONCLUSION

The invented method and system provide a platform for users to quickly solve their problems and share answers. This invention also improves the efficiency of users' asking and answering, and the computer's processing accuracy of questions and/or answers, and facilitates knowledge acquisition. Anybody may have some urgent questions and can obtain the answers using the invented method and system. Anybody can log on the invented system to ask or answer questions on the Web and do not need to install any software on the client side, so it will not bring any overload to any user. Meanwhile, enterprise users can also use the invented method and system to provide technical supports or consultancy services to their clients, employee training, and surveys, or use it as a tool for knowledge acquisition. Schools can use it as an education assistance system to enhance students' communication after class.

1. A system comprising:
a pattern database to store and manage question patterns and/or answer patterns, wherein a question pattern belongs to a class of patterns, and both question pattern and answer pattern are semantic patterns;
a question pattern comprises a question type and at least one blank where users should fill in with actual content to make the said pattern an actual question;
an answer pattern comprises at least one blank where users should fill in with actual content to make the said pattern an actual answer; each answer pattern is associated with a question pattern;
the pattern database also comprises a classification ontology to be used for classification, query, management, and extension of the question/answer patterns;
an asking unit to facilitate and process an asker user's asking a question using a question pattern;
an answering unit to facilitate and process an answerer user's providing an answer using an answer pattern.

2. (canceled)

3. A system as recited in claim 1, wherein the answering unit comprises an answer pattern selection unit to let the answerer select an answer pattern or just freetext to answer the question.

4. A system as recited in claim 1, further comprising a pattern creation unit to provide facilities to asker/answerer to create question/answer pattern according to the predefined rules for pattern creation or generation and the predefined labels to tag the structure and the elements of the question/answer patterns.

5. (canceled)

6. A system as recited in claim 1, wherein the question/answer pattern can comprise keywords, a keyword is one of the main words in the question or answer.

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method usable in the system as recited in claim 1, the method comprising:
Step 1, providing the asker with facilities for selecting a question pattern to ask his/her question, wherein the question pattern is semantic pattern, comprising question type and at least one blank(s) for the asker to fill in with actual content to make the said pattern an actual question;
Step 2, providing the answerer with facilities for selecting an answer pattern to answer a selected question, wherein the answer pattern is semantic pattern, comprising at least one blank where users should fill in with actual content to make the said pattern an actual answer; each answer pattern is associated with a question pattern.

20. (canceled)

21. A method as recited in claim 19, wherein further comprising a step for the asker to select to use freetext or a question pattern to ask the question a step for the answerer to answer the question using either freetext or an answer pattern.

22. (canceled)

23. (canceled)

24. (canceled)

25. (canceled)

26. A method as recited in claim 21, wherein comprising a pattern suggestion step of automatically selecting or generating a question pattern based on the freetext question when the user asks his/her question in freetext, the step actually comprising:
Step 101, analyzing the grammatical structure of the freetext question and obtaining the main structure of the sentence structure of freetext question;
Step 102, searching the pattern database using the sentence structure of the freetext question, jumping to Step 103 if the set of question patterns matching with the sentence structure of freetext question is not empty, or jumping to Step 104 otherwise (the set of question patterns matching with the sentence structure of freetext question is empty);
Step 103, from the set of question patterns obtained in Step 102, filtering out the question patterns whose blanks' semantic labels do not accord with the corresponding parts in the freetext question, and returning the remaining question patterns in the set;
Step 104, generating/creating and returning new question patterns based on the main structure of the freetext question and the predefined rules for pattern generation/creation.

27. (canceled)

28. A method as recited in claim 21, wherein further comprising a step of automatically providing answers to a user's question based on the accumulated questions and their answers in the historical database, the step actually comprising:
Step 2001, searching the pattern database using the query of the question pattern of the said question (the user's question) and finding a set of question patterns which are exactly the same as or similar to the question pattern of the said question;
Step 2002, finding from the historical database the set of previous questions using any question pattern in the set of question patterns found in Step 2001;
Step 2003, finding from WordNet or other similar synonym dictionaries the set of synonyms of the filling words/phrases of the blanks of the question pattern of the said question, and filtering out those previous questions whose filling words/phrases in the corresponding blanks are not among these synonyms;
Step 2004, returning to the asker the answers of the questions remaining in the set of previous questions after filtering in Step 2003.

29. (canceled)

30. (canceled)

31. (canceled)

32. (canceled)

33. (canceled)

34. A method as recited in claim 19, wherein further comprising a step of electronic commerce, wherein actually comprising one or more of the following steps:
providing the user with facilities of pricing his/her question with a nonnegative unit of money or other incentives he/she wish to pay/give for any correct answer(s) to his question so as to encourage other users to provide timely and high quality answers;
encouraging users to ask questions using question patterns by rewarding the users' pattern-form questions;
providing facilities for any user to raise a complaint to any other user for any fraud or other bad activities not allowed in the system, wherein the complained user is panelized if he/she is verified as wrong or the complaint raiser is panelized otherwise;
providing facilities for any user to do a survey of any topic in the system with certain award/price and/or certain conditions on the potential participants, all participants can earn a portion of the award according to the conditions after the survey;
providing facilities for any user to build his/her personal knowledge base by accumulating his/her personal question/answer pairs, the system automatically tries to answer any new question by searching the personal knowledge base on behalf of its owner/creator, and rewards its owner/creator if the found answer is selected by the asker as a correct answer;
evaluating the users' interests/authorities according to their questions/answers;
a personalized information service step, comprising recommending questions/answers to the users according to their interests/authorities;
an answer quality evaluation step, evaluating the answers' qualities.

35. (canceled)

36. (canceled)

37. A method as recited in claim 34, wherein the answer quality evaluation step evaluates the quality of an answer based on one or more of the following factors: its answerer's reputation, authority, timeliness of the answer, and the hyperlinks of the references in the answer.

38. A method as recited in claim 19 wherein further comprising a step of user reputation evaluation, wherein actually comprising.
Step 2601, recording and tracking the users' activities in the system;
Step 2602, analyzing the users' activities in the system to evaluate their reputations in the system;
Step 2603, providing facilities for users to rate others' reputations based on their activities;
Step 2604, calculating users' reputation values according to their reputations obtained in Step 2602 and/or Step 2603.

39. (canceled)

40. A method as recited in claim 34, wherein the personalized information service step further comprises:
Step 3701, periodically calculating and storing users' interest and/or authorities in each area (knowledge domain);
Step 3702, recommending a new question to those users whose authorities in the area of the new question are higher than a threshold; and/or Step 3703, recommending a new answer to those users whose interests in the area of its question are higher than a threshold, wherein the recommended user can decide whether to accept such recommendations.

41. A method as recited in claim 37, wherein the answer quality evaluation step further comprises:
Step 3801, providing the facilities for a user to set his/her quality evaluation preferences or use the system's default settings on quality evaluation of the answers to a given question, including the weights of the answerers' reputations, authorities, timeliness of the answers, and the hyperlinks of the references in the answers;
Step 3802, calculating the answers' personalized quality values based on the users' personal settings on quality evaluation preferences in Step 3801;
Step 3803, displaying the answers' quality values and/or using their quality values to sort or filter these answers.

42. A website for question answering, comprising:
a pattern database to store and manage question patterns and/or answer patterns; both question pattern and answer pattern are semantic patterns;
a question pattern comprises a question type and at least one blank where users should fill in with actual content to make the said pattern an actual question;
an answer pattern comprises at least one blank where users should fill in with actual content to make the said pattern an actual answer; each answer pattern is associated with a question pattern;
the pattern database also comprises a classification ontology to be used for classification, query, management, and extension of the question/answer patterns;
an asking unit to facilitate and process an asker user's asking a question using a question pattern;
an answering unit to facilitate and process an answerer user's providing an answer using an answer pattern.

43. A website as recited in claim 42, wherein the answer patterns are manually selected, or manually created, or automatically found from the pattern database by the answering unit as the answer pattern corresponding to the question pattern of the current question.

44. A website as recited in claim 42, wherein the asking unit further comprises an question pattern selection unit to let the asker select to use freetext or a question pattern to ask his/her question.

45. A website as recited in claim 42, further comprises a pattern creation unit to provide facilities to the asker/answerer to create question/answer pattern according to the predefined rules for pattern creation or generation and the predefined labels to tag the structure and the elements of the question/answer patterns.

46. A website as recited in claim 42, wherein the asking unit also comprises a pattern suggestion unit to automatically suggest the user with a list of question patterns for the user to select or confirm to use when the user asks a question in freetext. The pattern suggestion unit first analyzes the grammar of the freetext question and obtains its main structure, then finds from the pattern database a list of candidate patterns which match with the obtained main structure, and further removes from the list those candidate patterns whose blanks' semantic labels do not accord with the corresponding words/phrases in the freetext question. If there is no candidate pattern left in the list, the pattern suggestion unit automatically generates a few possible question patterns according to the obtained main structure of the freetext question and the predefined rules for pattern creation or generation and adds them to the list. Finally, the question patterns remaining in the list are suggested to the user for selection or confirmation.

47. A website as recited in claim 42, further comprising:
a historical database to store the accumulated questions, answers, and/or information about their corresponding patterns;
a history-based automatic answering unit to automatically provide answer(s) to a given question. The unit first finds from the historical database all the historical questions which use the same pattern used in the given question or its similar patterns, and then returns the answers of these historical questions whose filling parts for the blanks in their corresponding patterns match with the counterparts in the given question.

48. (canceled)

49. A website as recited in claim 42, further comprising an electronic commerce unit, wherein actually comprising one or more of the following units:
a question pricing unit to provide the user with facilities of pricing his/her question with a nonnegative unit of money or other incentives he/she wish to pay/give for any correct answer(s) to his question;
a pattern reward unit to reward any creator and/or user of any pattern; and/or
a user reputation unit to evaluate the users' reputations according to their activities in the system and/or their subjective and mutual appraisal by other users;
a user survey unit to let any user to do a survey of any topic in the system with certain award/price and/or certain conditions on the potential participants. All participants can earn a portion of the award according to the conditions after the survey;
a user complaint unit to let any user raise a complaint to any other user for any fraud or other bad activities now allowed in the system;
a personal knowledge base unit to let any user to accumulate his/her personal question/answer pairs. The system automatically tries to answer any new question by searching the personal knowledge base on behalf of its owner/creator, and rewards its owner/creator if the found answer is selected by the asker as a correct answer;
a user interest/authority unit to evaluate the users' interests/authorities according to their questions/answers;
a personalized information service unit to recommend questions/answers to the users according to their interests/authorities;
an answer quality evaluation unit to evaluate the answers' qualities.

50. A website as recited in claim 49, wherein the personalized information service unit comprises one or more of the following units:
a question recommendation unit to recommend a question to the users with high authorities in the area of the question;
an answer recommendation unit to recommend an answer to the users with high interest in the area of its question.

51. A website as recited in claim 49, wherein the answer quality evaluation unit evaluates the quality of an answer based on one or more of the following factors: its answerer's reputation, authority, timeliness of the answer, and the hyperlinks of the references in the answer.

52. A system as recited in claim 1, further comprising an answer clustering and quality evaluation unit to cluster all the answers to a question into a few classes, each containing similar answers, and evaluate the quality of each answer, and display the cluster information and quality information of these answers to users for them to read and store these information into a knowledge base of the system.

53. A system as recited in claim 1, further comprising a content analyzer to analyze a question's content and dispatches it to a relevant board.

54. A system as recited in claim 1, wherein each blank in a question/answer pattern is tagged by a semantic label to indicate the semantics of the content to be filled in the blank.
